(19) United States
(12) Patent Application Publication
(10) Pub. No.: US 2008/0000826 A1
(43) Pub. Date: Jan. 3, 2008

(54) ROLLED AXIAL FLOW FILTER AND METHODS

(76) Inventors: David B. Harder, Burnsville, MN (US); Gregory LaVallee, Monticello, MN (US); Jess T. Nordby, Minneapolis, MN (US)

Correspondence Address: MERCHANT & GOULD PC, P.O. BOX 2903, MINNEAPOLIS, MN, 55402-0903, US

(21) Appl. No.: 11/758,183

(22) Filed: Jun. 5, 2007

Related U.S. Application Data
(60) Provisional application No. 60/804,477, filed on Jun. 12, 2006.

(51) Int. Cl. B01D 29/46; B01D 63/00; B01D 63/06; B01D 63/10; B32B 37/12; C02F 1/44

(52) U.S. Cl. 210/321.61; 156/182; 210/321.72; 210/321.74; 210/321.78; 210/490

(57) ABSTRACT

Filter media includes a first layer of porous filter media having first and second opposite sides and first and second edges; a first porous screen oriented on the second side of the first layer of porous filter media, the first porous screen having first and second edges; a second layer of porous filter media having first and second opposite sides and first and second edges, the second side of the second layer of porous media oriented on the first porous screen, a first sealant securing the first layer, first screen, and second layer together adjacent to the first edges of the first layer, first screen, and second layer; a second screen oriented on the first side of the second layer, the second screen having first and second edges; and a second sealant securing the second screen and the second layer adjacent to the second edges of the second screen and second layer. The filter media can be coiled into a filter element resulting in a plurality of dirty fluid inlets between the first layer second side and second layer second side, and a plurality of clean fluid outlets between the first layer first side and second layer first side. Methods of making filter elements include providing a four layered construction of media, screen, media, and screen, and then coiling it into a filter element.

Priority is claimed under 35 U.S.C. § 119(e) to provisional patent application Ser. No. 60/804,477 filed Jun. 12, 2006, incorporated herein by reference in its entirety.

### TECHNICAL FIELD

This disclosure relates to filter media constructions, filter elements formed from such media constructions, and method for constructing and filtering.

### BACKGROUND

It is known to construct filter elements in a way to have straight through, or axial, flow. One example of such types of filter elements include a corrugated sheet of filter media secured to a flat or uncorrugated sheet of media. The corrugated sheet secured to the flat sheet can be rolled into a coiled construction to result in a filter element having flutes, with selected ones of the flutes being open at an upstream end and closed at a downstream end, while selected ones of the flutes are closed at the upstream end and open at the downstream end.

Sometimes, it is desirable to use filter media that cannot easily be corrugated. Either the media lacks being able to hold a corrugation shape, or it is too fragile to run through a corrugation machine. Improvements are desirable.

### SUMMARY

Filter media is provided including alternate layers of media and screen rolled into a coiled construction. Alternating ends of the roll are secured together.

In one embodiment, filter media is provided including a first layer of porous filter media having first and second opposite sides and first and second edges; the first porous screen oriented on the second side of the first layer of porous filter media, the first porous screen having first and second edges; a second layer of porous filter media having first and second opposite sides and first and second edges, the second side of the second layer of porous media oriented on the first porous screen; a first sealant securing the first layer, first screen, and second layer together adjacent to the first edges of the first layer, first screen, and second layer; a second screen oriented on the first side of the second layer, the second screen having first and second edges; and a second sealant securing the second screen and second layer adjacent to the second edges of the second screen and second layer.

In one embodiment, the first layer of porous filter media includes cellulose material, or synthetic material, or a blend thereof and includes a meltblown polymer on the second side of the first layer. The second layer of porous filter media, in one embodiment, includes cellulose material, or synthetic material, or a blend thereof and includes a meltblown polymer on the second side of the second layer.

In one embodiment, the first and second screens comprise metal or plastic.

A filter element is provided including filter media, as characterized above, being rolled into a coiled filter element. The second layer first side and second screen are secured to the first layer first side by the second sealant to form a filter element having a plurality of dirty fluid inlets between the first layer second side and second layer second side; and a plurality of clean fluid outlets between the first layer first side and the second layer first side.

In one embodiment, the first and second sealant each comprises an adhesive or urethane.

In another aspect, a method of making a filter element includes providing a media construction, as characterized above, and coiling the media construction to secure the second layer first side and second screen to the first layer first side to form a filter element having a plurality of dirty fluid inlets between the first layer second side and second layer second side; and a plurality of clean fluid outlets between the first layer first side and the second layer first side.

### BRIEF DESCRIPTION OF THE DRAWINGS

FIG. 1 is a schematic, perspective view of a media construction according to principles of this disclosure;

FIG. 2 is a schematic, perspective view of a filter element made from the media construction of FIG. 1, constructed according to principles of this disclosure;

FIG. 3 is a schematic, perspective view of another filter element made from the media construction of FIG. 1, constructed according to principles of this disclosure; and

FIG. 4 is a schematic, perspective view of the element of FIG. 3, as viewed from an end opposite of FIG. 3.

### DETAILED DESCRIPTION

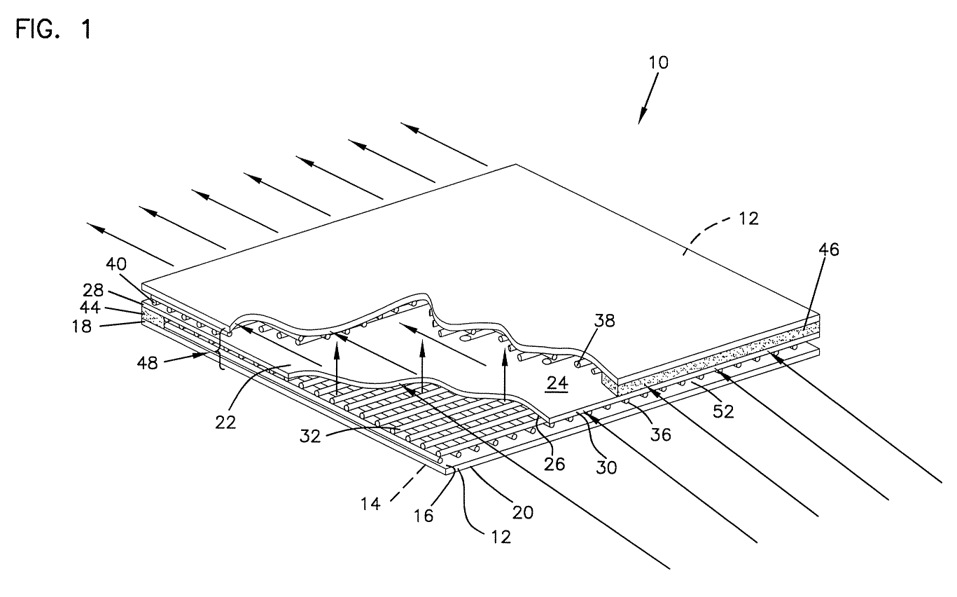

FIG. 1 depicts a filter media construction generally at 10. In the embodiment shown, the media construction 10 includes a first layer 12 of porous filter media having a first side 14 and an opposite, second side 16. In the orientation in FIG. 1, the first side 14 corresponds to a lower or bottom side, while the second side 16 corresponds to an upper or top side. The first layer of media 12 also includes first and second opposite end edges 18, 20. In the embodiment shown in FIG. 1, the first edge 18 corresponds to a downstream edge, while the edge 20 corresponds to an upstream edge.

The media construction 10 also includes a second layer of media 22. The second layer of media 22 has first and second opposite sides 24, 26. The first side 24, in the embodiment shown, is depicted in the orientation of FIG. 1 as being an upper or top surface, while the second side 26 is depicted in the orientation in FIG. 1 as being a lower surface. The second layer 22 also has first and second edges 28, 30. In the embodiment shown, the first edge 28 corresponds to a downstream edge, while the second edge 30 corresponds to an upstream edge.

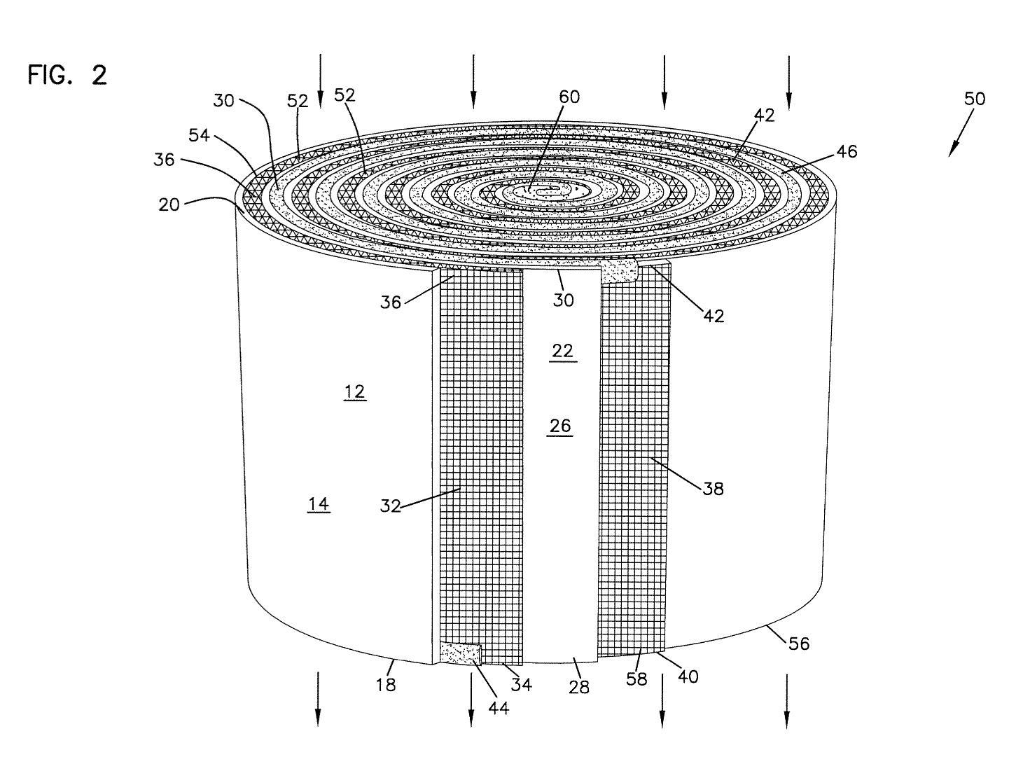

A first porous screen 32 is provided. In the embodiment shown, the first screen 32 is oriented on the second side 16 of the first layer 12. The first screen 32 also has first and second edges 34, 36. In the embodiment of FIG. 1, the first edge 34 is not viewable, but it can be seen in FIG. 2. The second edge 36 corresponds to an upstream edge, while the first edge 34 corresponds to a downstream edge. In the embodiment shown, the first screen 32 is sandwiched between the second side 16 of the first layer 12 and the second side 26 of the second layer 22.

A second screen 38 is oriented on the first side 24 of the second layer 22. The second screen 38 has first and second edges 40, 42. The first edge 40 corresponds to a downstream edge, while the second edge 42 corresponds to an upstream edge. The second edge 42 is not viewable in FIG. 1, but can be seen in FIG. 2.

The first layer 12, first screen 32, and the second layer 22 are secured together adjacent to the first edges 18, 28, and 34, of the first layer 12, second layer 22, and first screen 32, respectively. As can be seen in FIGS. 1 and 2, the second side 26 of the second layer 22 is oriented on the first screen 32. These first edges 18, 28, 34 can be secured together with a bead 44 of sealant. The sealant 44 can include various types of adhesive or urethane.

The second screen 38 and the second layer 22 are secured together adjacent to the second edges 30 and 42. In the embodiment shown, a bead 46 secures together the second screen 38 and the first side 24 of the second layer 22. The bead 46 can be various types of adhesive or urethane.

In FIG. 1, another layer of media is illustrated over the second screen 38. This is shown in phantom at reference numeral 12, because the four layer construction 48 including the first layer 12, first screen 32, second layer 22, and second screen 38 is rolled or coiled such that the bead 46 secures the second screen 38 and the second layer 22 to the first side 14 of the first layer 12 as it is being rolled or coiled.

FIG. 2 illustrates the media construction 10 in the form of a coiled filter element 50. The coiled filter element 50 is made by taking the four layer construction 48 and coiling it to secure the second layer first side 24 and the second screen 38 to the first layer first side 14 to form the filter element 50. The filter element 50 has a plurality of dirty fluid inlets 52 defined between the first layer second side 16 and the second layer second side 26. The dirty fluid inlets 52 correspond to the upstream and adjacent to the second edges 20, 30, 36, and 42. The dirty fluid inlets 52 are open at the upstream end of the element 50 and are blocked by adhesive bead 44 at the downstream end 56 of the element 50.

The filter element 50 also has a plurality of clean fluid outlets 58 defined between the first layer first side 14 and the second layer first side 24. The clean fluid outlets 58 have their channels blocked by bead 46 at the upstream end 54 of the element 50. With such a construction, fluid to be filtered, as it approaches the upstream end 54 of the element 50 is prevented from flowing into the clean fluid outlets 58 by the adhesive bead 46. Instead, the fluid must flow through the dirty fluid inlets 52, which have their upstream ends open and unblocked. The fluid enters the element 50 through the dirty fluid inlets 52, but is prevented from exiting the element 50 through the dirty fluid inlets 52 because of the presence of the adhesive bead 44 blocking the dirty fluid inlet channels 52 at the downstream end 56. Instead, the fluid is forced to flow through at least one of the first and second layers 12, 22 in order to get to one of the clean fluid outlets 58 in order to exit through the downstream end 56. The clean fluid outlets 58 have an open downstream end 56 that allows the fluid to exit the filter element 50. When the fluid flows through at least one of the layers 12, 22, the media layers 12, 22 clean or filter the fluid.

The element 50 is made by providing the first layer 12, orienting the first screen 32 on the second side 16 of the first layer 12; applying adhesive bead 44 along the first edge 18, 34; and then orienting the second layer 22 on the first screen 32 and first layer 12. The second layer 22 will be secured to the first screen 32 and the first layer 12 with the adhesive bead 44. Next, the second screen 38 is oriented on the first side 24 of the second layer 22, and the adhesive bead 46 is applied adjacent to the second edge 30 and second edge 42. This results in the four layer construction 48. This four layer construction 48 is then coiled or rolled such that the second screen 38 and first side 24 of the second layer 22 is secured to and against the first side 14 of the first layer 12.

In some embodiments, including the embodiment of FIG. 2, the filter element 50 will include a core member 60. When the four layer construction 48 is coiled or rolled, the bead 46 and the second screen 38 and the first side 24 of the second layer 22 is initially coiled around and secured to the core member 60. In the embodiment shown in FIG. 2, the core member 60 is cylindrical, resulting in the filter element 50 being cylindrical. In other embodiments, the filter element 50 can be coreless.

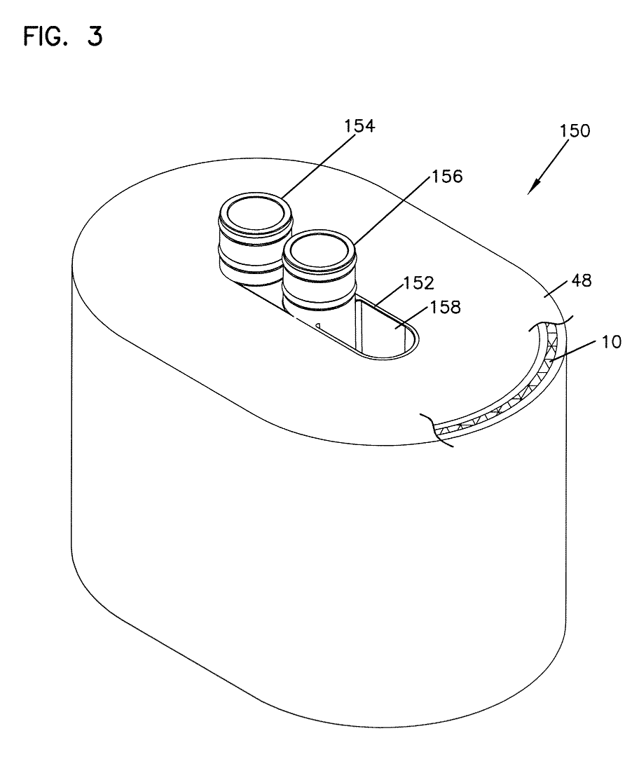

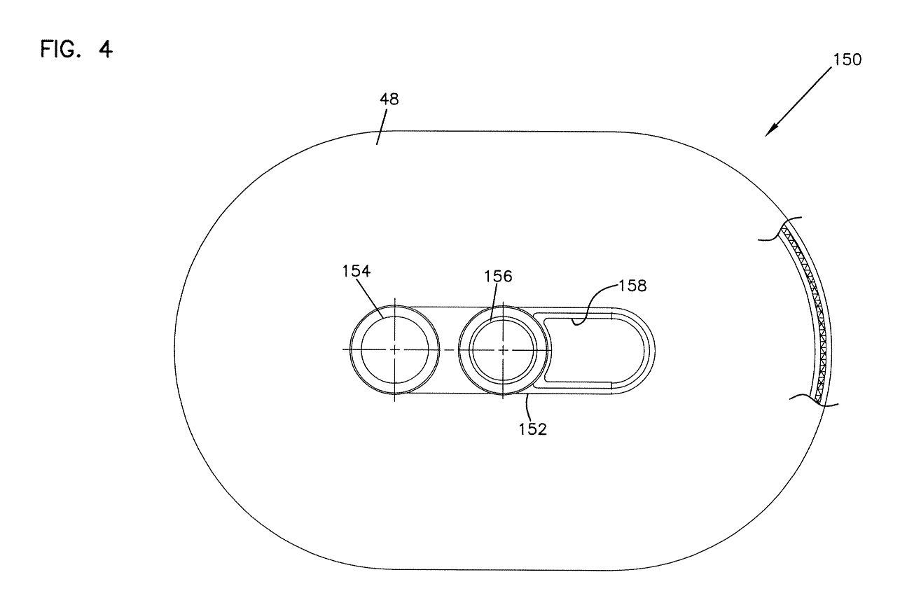

Alternatively, the core member 60 can be elongated to result in an obround, an oval, or a racetrack shaped filter element. A racetrack shaped element has generally straight sides joined by curved ends, for example, semi-circular ends. FIGS. 3 and 4 illustrate a filter element 150 having a race-track shape. The element 150 utilizes the four layer construction 48 coiled around a center core construction 152. The media 10 is shown schematically in FIG. 3 on only a partial section of the element 150. It should be understood that the element 150 is made from the media 10 coiled around the core 152, and for clarity, all of the media 10 is not shown in FIGS. 3 and 4. The element 150 is shown also, in this embodiment, to have fluid flow tubes 154, 156 and a channel 158. The tubes 154, 156 are for, in one embodiment, conveying fluid, while the channel 158 is for accommodating other structure through the element 150. The element 150 can be used in, for example, a fuel system application as described in U.S. provisional patent application 60/763,743 filed Jan. 30, 2006; U.S. provisional patent application 60/775,467 filed Feb. 22, 2006; and U.S. provisional patent application 60/822,974 filed Aug. 21, 2006, each incorporated by reference herein. It should be understood that other embodiments of an oval or racetrack-shaped element will include cores of varying geometries and functions, including solid cores, cores without tubes or other core structures. Other oval or racetrack-shaped embodiments are coreless.

Various types of material are useable for media construction 10. The first and second media layers 12, 22 may include cellulose material, or synthetic material, or a blend of cellulose and synthetic material. In one embodiment, there will be a meltblown polymer, such as a felt, on one of the sides of the first and second layers 12, 22. In certain systems, the second side 16 of the first layer 12 and the second side 26 of the second layer 22 will have the meltblown polymer. This corresponds to the plurality of dirty fluid inlets 52 of the filter element 50. Other types of media are useable.

The first and second screens 32, 38 may include metal, or plastic, or a composite.

The adhesive beads 44, 46 can include a variety of adhesives or sealants. For example, they can be various types of glue, epoxies, or urethane. In some systems, hot melt may also be used.

The filter element 50 can be used in a variety of applications including fuel filters, lube filters, hydraulic fluid filters, transmission fluid filters, and other liquids. It is also possible to use the filter element 50 for filtration of air or other gases.

Many embodiments are contemplated utilizing the principles described herein.

What is claimed is:

1. Filter media comprising:
(a) a first layer of porous filter media having first and second opposite sides and first and second edges;
(b) a first porous screen oriented on the second side of the first layer of porous filter media; the first porous screen having first and second edges;
(c) a second layer of porous filter media having first and second opposite sides and first and second edges; the second side of the second layer of porous media oriented on the first porous screen;
(d) a first sealant securing the first layer, first screen, and second layer together adjacent to the first edges of the first layer, first screen, and second layer;
(e) a second screen oriented on the first side of the second layer; the second screen having first and second edges; and
(f) a second sealant securing the second screen and the second layer adjacent to the second edges of the second screen and second layer.

2. Filter media according to claim 1 wherein:
(a) the first layer of porous filter media includes cellulose material, or synthetic material, or a blend thereof and includes a meltblown polymer on the second side of the first layer; and
(b) the second layer of porous filter media includes cellulose material, or synthetic material, or a blend thereof and includes a meltblown polymer on the second side of the second layer.

3. Filter media according to claim 2 wherein:
(a) the first screen comprises metal or plastic; and
(b) the second screen comprises metal or plastic.

4. A filter element comprising:
(a) a media construction including:
(i) a first layer of porous filter media having first and second opposite sides and upstream and downstream edges;
(ii) a first porous screen oriented on the second side of the first layer of porous filter media; the first porous screen having upstream and downstream edges;
(iii) a second layer of porous filter media having first and second opposite sides and upstream and downstream edges; the second side of the second layer of porous media oriented on the first porous screen;
(iv) a first sealant securing the first layer, first screen, and second layer together adjacent to the upstream edges of the first layer, first screen, and second layer;
(v) a second screen oriented on the first side of the second layer; the second screen having upstream and downstream edges; and
(vi) a second sealant securing the second screen and the second layer adjacent to the downstream edges of the second screen and second layer;
(b) the media construction being rolled into a coiled filter element; the second layer first side and second screen being secured to the first layer first side by the second sealant to form a filter element having:
(i) a plurality of dirty fluid inlets between the first layer second side and second layer second side; and
(ii) a plurality of clean fluid outlets between the first layer first side and the second layer first side.

5. A filter element according to claim 4 wherein:
(a) the first layer of porous filter media includes cellulose material, or synthetic material, or a blend thereof and includes a meltblown polymer on the second side of the first layer; and
(b) the second layer of porous filter media includes cellulose material, or synthetic material, or a blend thereof and includes a meltblown polymer on the second side of the second layer;
(i) the plurality of dirty fluid inlets being defined by the meltblown polymer on the second side of the first layer and the meltblown polymer on the second side of the second layer.

6. A filter element according to claim 4 wherein:
(a) the first screen comprises metal or plastic; and
(b) the second screen comprises metal or plastic.

7. A filter element according to claim 4 wherein:
(a) the first and second sealant each comprises an adhesive.

8. A filter element according to claim 4 wherein:
(a) the first and second sealant each comprises urethane.

9. A filter element according to claim 4 further comprising:
(a) a core member in a center of the coiled filter element.

10. A filter element according to claim 4 wherein:
(a) the element is cylindrical.

11. A filter element according to claim 4 wherein:
(a) the element is racetrack-shaped.

12. A filter element according to claim 4 wherein:
(a) the element is oval-shaped.

13. A method of making a filter element; the method comprising:
(a) providing a first layer of porous filter media having first and second opposite sides and first and second edges;
(b) orienting a first porous screen on the second side of the first layer of porous filter media; the first porous screen having first and second edges;
(c) orienting a second layer of porous filter media having first and second opposite sides and first and second edges on the first porous screen so that the second side of the second layer of porous media is oriented on the first porous screen;
(d) securing the first layer, first screen, and second layer together at a location adjacent to the first edges of the first layer, first screen, and second layer;
(e) orienting a second screen on the first side of the second layer; the second screen having first and second edges;
(f) securing the second screen and the second layer at a location adjacent to the second edges of the second screen and second layer to result in a media construction; and
(g) coiling the media construction to secure the second layer first side and second screen to the first layer first side to form a filter element having:
(i) a plurality of dirty fluid inlets between the first layer second side and second layer second side; and
(ii) a plurality of clean fluid outlets between the first layer first side and the second layer first side.

14. A method according to claim 13 wherein:
(a) the step of securing the first layer, first screen, and second layer together includes applying a bead of adhesive adjacent to the first edges of the first layer and first screen before the step of orienting a second layer on the first screen.

15. A method according to claim 14 wherein:
(a) the step of securing the second screen and the second layer together includes applying a bead of adhesive adjacent to the second edges of the second screen and second layer.

16. A method according to claim 15 wherein:
(a) the step of applying a bead of adhesive adjacent to the first edges of the first layer and first screen includes applying a bead of at least one of epoxy or urethane; and
(b) applying a bead of adhesive adjacent to the second edges of the second screen and second layer includes applying a bead of at least one of epoxy or urethane.

17. A method according to claim 13 wherein:
(a) the step of providing a first layer includes providing a first layer of porous filter media including cellulose material, or synthetic material, or a blend thereof and includes a meltblown polymer on the second side of the first layer; and
(b) the step of providing a second layer includes providing a second layer of porous filter media including cellulose material, or synthetic material, or a blend thereof and includes a meltblown polymer on the second side of the second layer;
(i) the plurality of dirty fluid inlets being defined by the meltblown polymer on the second side of the first layer and the meltblown polymer on the second side of the second layer.

18. A method according to claim 13 wherein:
(a) the step of coiling includes providing a core member and coiling the media construction around the core member.
